(19) United States
(12) Patent Application Publication
(10) Pub. No.: US 2007/0119897 A1
(43) Pub. Date: May 31, 2007

(54) Propellant container for a combustion-engined setting tool and propellant container receptacle of the setting tool

(76) Inventors: Stefan Boenig, Achberg-Esseratsweiler (DE); Ulrich Rosenbaum, Wangs (CH); Mario Zahner, Chur (CH); Iwan Wolf, Untervaz (CH)

Correspondence Address: ABELMAN, FRAYNE & SCHWAB, 666 THIRD AVENUE, 10TH FLOOR, NEW YORK, NY, 10017, US

(21) Appl. No.: 11/603,997

(22) Filed: Nov. 21, 2006

(30) Foreign Application Priority Data
Nov. 25, 2005 (DE) 10 2005 000 166.1

(51) Int. Cl. B25C 1/14

(52) U.S. Cl. 227/10

(57) ABSTRACT

A propellant container for a hand-held setting tool includes a valve outlet (23) for delivery of propellant, and a terminal element (24) provided at an end region (29) of the propellant container (20) remote from the valve outlet (23) and having a locking member (25) for securing the propellant container (20) in a propellant container receptacle (16) of the setting tool (10) and having a terminal element (14) for the valve outlet (23) of the propellant container (20), and a counter-locking element (35) provided in an end region (39) of the propellant container receptacle (16) adjoining the receiving opening (19) and cooperating with the locking member (25) of the propellant container (20).

### BACKGROUND OF THE INVENTION

1. Field of the Invention

The present invention relates to a propellant container for a combustion-engined hand-held setting tool and including a valve outlet for delivery of propellant and a connection element for connecting the propellant container with the setting tool and having a locking member for securing the propellant container in the setting tool. The present invention also relates to a propellant container receptacle of the hand-held propellant-driven setting tool for receiving the propellant container and including an opening through which the propellant container is insertable in the receptacle, a connection element for the valve outlet of the propellant container, and counter-locking means cooperating with the locking member of the propellant container.

2. Description of the Prior Art

U.S. Pat. No. 6,523,860 discloses a setting tool having a metering valve for fuel arranged in the tool housing, and a receiving space for a fuel-containing container. An adapter, which functions as connection means, is pinned into the valve head of the container. The connection means cooperates with a lock arranged in the receiving space for releasably securing the container in the receiving space and to provide for fuel delivery to the metering valve.

The drawback of the known setting tool consists in that removal of the fuel container from the receiving space with one hand is not possible.

Accordingly, an object of the present invention is to provide a propellant (fuel) container and a container receptacle of the setting tool with which the above-discussed drawback of a conventional setting tool is eliminated.

### SUMMARY OF THE INVENTION

This and other objects of the present invention, which will become apparent hereinafter, are achieved by providing a propellant container in which the connection means with the locking member is located at an end region of the container remote from the valve outlet, and by providing a container receptacle in which the counter-locking means of the container receptacle are located in an end region of the receptacle adjoining the opening through which the container is inserted.

The foregoing novel features of the present invention permit the user to easily remove the propellant container from the propellant container receptacle with one hand because the locking member is provided at the end of the container which is being grasped for removal of the container from the receptacle. Transfer of the hand after release of the locking member is not necessary any more. Further, the propellant container, upon being inserted in the propellant container receptacle, is supported at both ends or end regions, with the valve element being connected in fluid or propellant communication with the connection means for the valve outlet of the receptacle. The propellant container is supported at one of its ends, at least in the radial direction, through the valve outlet, by the valve outlet connection means of the receptacle, while the opposite end of the propellant container is secured by the locking member. The foregoing arrangement insures a reliable fluid connection of the propellant container with the setting tool. The connection element with the locking member is not releasably mounted on the propellant container, rather, it is fixedly secured with glue or by direct injection of the plastic connection member onto the container. However, the connection element can be pinned on an end of the propellant container as an adaptor.

It is advantageous, when there is provided an operational member for the locking member. With the operational member, the locking connection can be easily released, without the need for the user to grasp the locking member that can possibly be not easily accessible. With the arrangement of the operational member in the end region of the propellant container remote from the valve outlet, an easy handling with one hand is insured, i.e., insertion and removal of the propellant container can be effected with one hand, without grasping the entire container.

According to a constructively advantageous embodiment of the invention, the locking member is formed as a spring shackle having a web for connecting the locking member with the connection element, and a locking hook provided at an end of the locking member remote from the web. The operational member is arranged on the spring shackle between the web and the locking hook.

It is advantageous when the connection element has at least one element for securing the propellant container in the container receptacle without the possibility of rotation relative thereto. The securing element prevents rotation of the propellant container in the propellant container receptacle. Thereby radial shearing forces, which could have acted on the locking member and could have damaged it if the propellant container would have rotated upon its removal from the propellant container receptacle, are eliminated.

According to a constructively advantageous embodiment of the invention, the at least one securing element is formed as a groove-shaped recess provided on the connection element and extending in a direction of a longitudinal axis of the propellant container.

It is further advantageous when the connection element is formed as closing means such as, e.g., as a closing body or as a housing cover for closing the propellant container receptacle of the setting tool. Therefore, an additional housing cover or additional closing of the receptacle opening is not any more necessary.

The counter-locking means of the propellant container receptacle is provided in the end region of the receptacle adjacent to the receptacle opening, which insures an easy handling, i.e., insertion and removal of the propellant with one hand and which provides for a reliable locking in this end region of the receptacle.

Advantageously, the counter-locking means has a first counter-locking element for releasably securing the propellant receptacle in a first locking position. In the first locking position, the connection element of the propellant container closes the opening in the propellant container receptacle, without establishing a propellant flow between the setting tool and the propellant container.

It is further advantageous when the counter-locking means has a second counter-locking element for releasably securing the propellant receptacle in a second locking position. In the second locking position, the valve outlet of the propellant container is connected with the valve outlet connection element of the receptacle, providing for flow of the propellant between the setting tool and the propellant container.

It is advantageous when the propellant container receptacle has at least one element for securing the propellant container in the container receptacle without the possibility of rotation relative thereto. Advantageously, it cooperates with a corresponding element of the propellant container, enhancing the advantageous effect of the securing element of the propellant container. Thereby, as it has already been discussed above, the radial shearing forces, which could have acted on the locking member and could have damaged it if the propellant container would have rotated upon its removal from the propellant container receptacle, are eliminated.

According to a constructively advantageous embodiment of the invention, the at least one securing element is formed as a rib-shaped projection extending in a direction of a longitudinal axis and receivable in a groove-shaped recess provided on the connection element and extending in a direction of a longitudinal axis of the propellant container. The rib-shaped projection has an outer profile corresponding to the inner profile of the groove-shaped recess.

The novel features of the present invention, which are considered as characteristic for the invention, are set forth in the appended claims. The invention itself, however, both as to its construction and its mode of operation, together with additional advantages and objects thereof, will be best understood from the following detailed description of the preferred embodiment, when read with reference to the accompanying drawings.

### BRIEF DESCRIPTION OF THE DRAWINGS:

The drawings show:

FIG. 1 a schematic, partially cross-sectional view of a hand-held setting tool with a propellant container receptacle according to the present invention for receiving a propellant container according to the present invention;

FIG. 2 a cross-sectional view of the propellant container receptacle of the setting tool with the propellant container received therein, in a second locking position;

FIG. 3 a cross-sectional view of the propellant container receptacle of the setting tool with the propellant container received therein, in a first locking position;

FIG. 4 a cross-sectional view of the propellant container receptacle of the setting tool with the propellant container outside of the receptacle; and

FIG. 5 a side, partially cross-sectional view of the propellant container receptacle in a position pivoted by 90 to that of FIG. 2, with the propellant container received therein, in a second locking position.

### DETAILED DESCRIPTION OF THE PREFERRED EMBODIMENTS

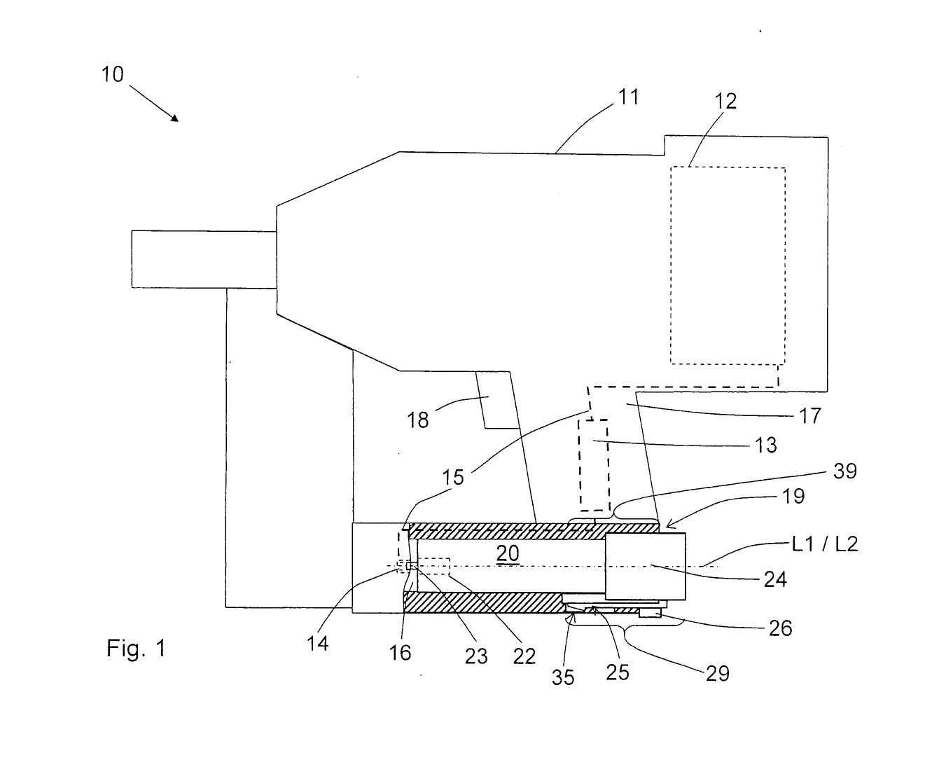

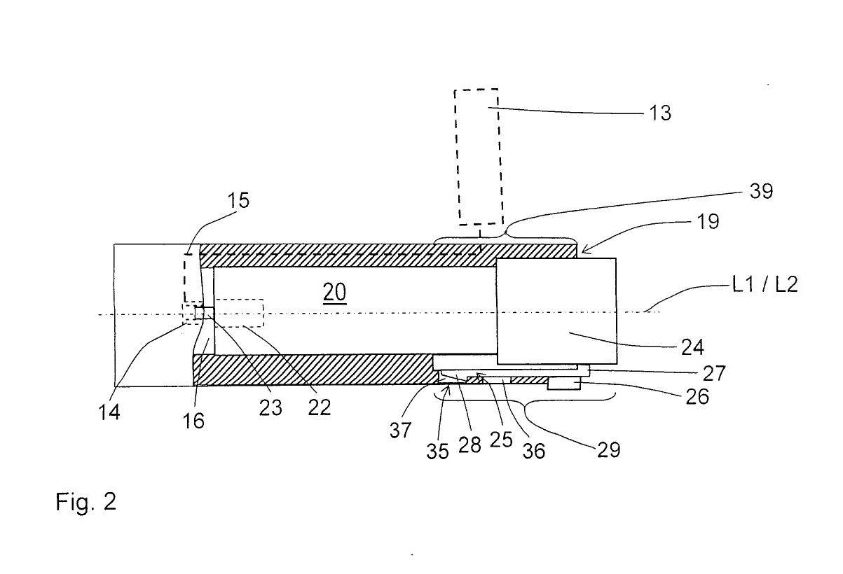

FIGS. 1-5 show a setting tool according to the present invention which is driven with liquid or gaseous fuel which forms the propellant, and is equipped with a propellant container 20 according to the present invention. The setting tool 10 has a housing 11 with a handle 16 formed thereon. On the handle 16, there is provided an actuation switch 17 for initiating a setting process. The setting tool 10 further includes a setting mechanism having a combustion chamber 12 for combusting an air-propellant mixture. The propellant container 20 is replaceably received in a receptacle 16 according to the present invention of the setting tool 10. In the embodiment shown in the drawings and described here, the propellant container is formed as a gas vessel. The propellant container 20 is inserted into the receptacle 16 through an opening 19 of the receptacle 16. The propellant container 20 has, at one of its ends, a valve outlet 23 of a valve 22 through which the propellant can flow out of the propellant container receptacle 20. In the propellant container receptacle 16, there is provided a terminal element 14 such as, e.g., a terminal union. The terminal union 14 is connected with the valve outlet 23 when the propellant container 20 is completely inserted in the propellant container receptacle 16, as shown in FIGS. 1-2. Appropriate sealing means such as, e.g., gaskets can insure the leak tightness of the socket connection. The terminal element 14 is connected by a propellant conduit 15 with a metering device 13 that, e.g., includes a valve. The propellant conduit 15 further connects the metering device 13 with the combustion chamber 12. In this way, propellant or fuel flows from the propellant container 20 through the propellant conduit 15 and the metering device 13 in the combustion chamber 12 of the setting tool 10.

For releasable securing the propellant container 20 in the propellant container receptacle 16, three is provided at an end or end region 29 of the propellant container 20 opposite the valve outlet 23, a terminal element 24 having a locking member 25. The terminal element 24 is formed as closing means or a closing body for an opening 19 of the propellant container receptacle 16. The locking member 25 is formed as a spring shackle provided at one of its ends with a web 27 securable to the terminal element 24 and, at its other end, with a locking hook 28. On the locking member 25, there is further arranged an actuation member 26, which is manually actuated by the tool user for pivoting the locking hook 28 on the spring shackle in a direction of the terminal element 24. Preferably, the terminal element 24 is formed together with the locking member 25 and the actuation member 26 as a one-piece part as a plastic injection-molded part.

The locking member 25 of the propellant container 20 cooperates with a counter-locking member 35 provided at an end region 39 of the propellant container receptacle 16 adjacent to the opening 19. The counter-locking means 35 has a first counter-locking element 36 and a second counter-locking element 37 formed as locking openings. The locking hook 28 engages in these locking openings for securing the propellant container 20 in the propellant container receptacle 16 in two different locking positions.

In FIGS. 1-2, the propellant container 20 is held in the propellant container receptacle 16 in the second position in which the valve outlet 23 is connected with the terminal element 14 or is inserted therein. In the second position, the locking hook 28 of the locking member 25 engages the second counter-locking element 37. In the second position, as it has already been described, propellant is fed through the propellant conduit 15 and the metering device 13 to the combustion chamber 12. The opening 19 is closed with the terminal element 14 formed as closing means or closing body, so that no dirt can penetrate in the propellant container receptacle 16.

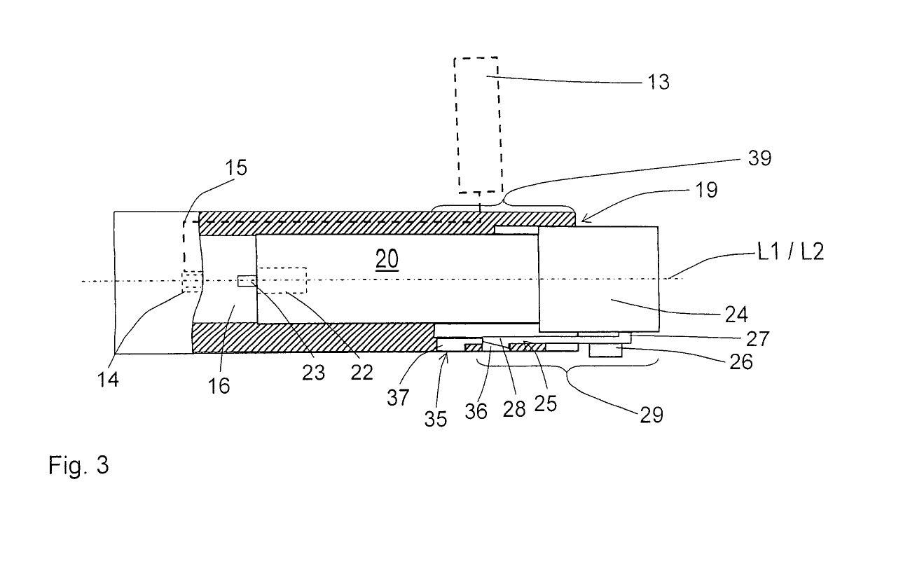

When the setting tool 10 need not be used for a long time, it makes sense to disconnect the propellant container 20 from the metering device 13. To this end, the propellant container 20 need not be completely disconnected from the propellant container receptacle 16. Rather, by actuation of the actuation member 26 and release of the locking hook 28 from the second locking opening (the second counter-locking element 37), and a partial withdrawal of the propellant container 20 from the container receptacle 16, the propellant container 20 is displaced to a first locking position in which the locking hook 28 engages the first counter-locking element. In the first locking position, the valve outlet 23 is disconnected from terminal element 14 (please see FIG. 3). The actuation of operational member 26 of the locking member 25 and withdrawal of the propellant container 20 can be carried out with one hand. The valve outlet 23 is closed in this position with the valve 22. In the first locking position, likewise, the opening 19 of the propellant container receptacle 16 is closed by the terminal element 24 which is formed as a closing body, and no dirt penetrates in the propellant container receptacle 16. Thus, the propellant container 20 can be supported on the setting tool 10 also in the first locking position.

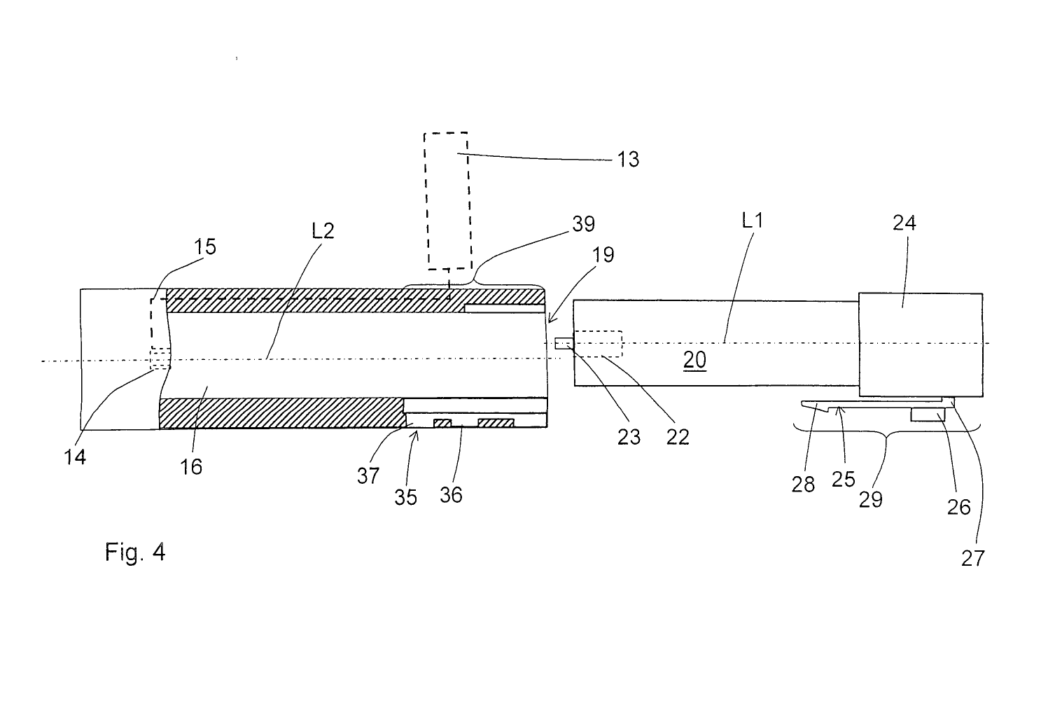

In FIG. 4, the propellant container 20 is completely withdrawn from the propellant container receptacle 16 after actuation of the operational member 26 anew for disconnecting the locking hook 28 from the first locking opening (the first counter-locking element 26). With the propellant container 20 being withdrawn, a new propellant container can be received in the propellant container receptacle 16.

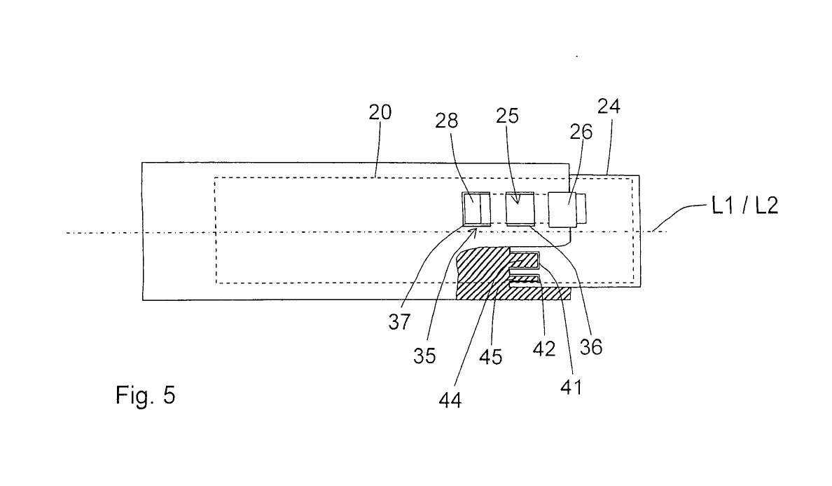

As shown in FIG. 5, the propellant container 20 has means for securing the propellant container 20 in the propellant container receptacle 16 without possibility of rotation relative thereto. The securing means includes, in the embodiment shown in the drawings, a first groove-shaped recess 41 and a second groove-shaped recess 42 provided both on the terminal element 24. The recesses 41, 42 extend in the direction of a longitudinal axis L1 of the propellant container 20 and have respectively, different widths (in a direction transverse to their longitudinal extent). Thereby, an inadvertent rotation of the propellant container 20 in the propellant container receptacle 16 is prevented, which, e.g., can take place upon removal of the propellant container 20. By forming the groove-shaped recesses 41, 42 with different width, simultaneously, there is produced a key profile that can characterize the propellant contained in the propellant container 20.

Upon insertion of the propellant container 20 in the propellant container receptacle 16, a first rib-shaped projection 44 and a second rib-shaped projection 45 of the second means for securing the propellant container 20 in the propellant container receptacle 16, which is provided in the propellant container receptacle 16, penetrate into the groove-shaped recesses 41, 42, respectively. The rib-shaped projections 44, 45 extend in the direction of a longitudinal axis L2 of the propellant container receptacle 16. The outer profile of the rib-shaped projections 44, 45 corresponds to the inner profile of the groove-shaped recesses 41, 42 and for corresponding closing profile. The key and closing profiles can define, along with securing the propellant container 20 in the propellant container receptacle 16 without a possibility of rotation relative thereto, which propellant containers 20 can be used with the setting tool 10, in order to prevent use of a non-allowable fuel that can damage the setting tool or result in an erroneous setting.

By aligning the groove-shaped recesses 41, 42, and the rib-shaped projection in the directions of axes L1, L2, respectively, the propellant container 20 is properly aligned in the propellant container receptacle 16, so that tilting of the propellant container 20 in the propellant container receptacle 16 is prevented.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A propellant container for a hand-held setting tool, comprising a valve outlet (23) for delivery of propellant; and a terminal element (24) provided at an end region (29) of the propellant container (20) remote from the valve outlet (23) for connecting the propellant container (20) with the setting tool (10) and having a locking member (25) for securing the propellant container (20) in the setting tool (10).

2. A propellant container according to claim 1, further including an operational member (26) for displacing the locking member (25).

3. A propellant container according to claim 2, wherein the locking member (25) is formed as a spring shackle having a web (27) for connecting the locking member (25) with the terminal element (24), and a locking hook (28) provided at an end of the locking member (25) remote from the web (27), and wherein the operational member (26) is arranged on the spring shackle between the web (27) and the locking hook (28).

4. A propellant container according to claim 1, wherein the terminal element (24) has at least one element for securing the propellant container (20) in the container receptacle (16) without the possibility of rotation relative thereto.

5. A propellant container according to claim 1, wherein the at least one securing element comprises at least one groove-shaped recess (41, 42) provided on the terminal element (24) and extending in a direction of a longitudinal axis (L1) of the propellant container (20).

6. A propellant container according to claim 1, wherein the terminal element (24) is formed as closing means for closing a propellant container receptacle (16) of the setting tool.

7. A propellant container receptacle of a hand-held propellant-driven setting tool for receiving a propellant container having a valve outlet (23) for delivery of propellant, and a terminal element (24) provided at an end region (29) of the propellant container (20) remote from the valve outlet (23) for connecting the propellant container (20) with the setting tool (10) and having a locking member (25) for securing the propellant container (20) in the setting tool (10), the propellant container receptacle (16) comprising an opening (19) through which the propellant container (20) is insertable in the receptacle (16); a terminal element (14) for the valve outlet (23) of the propellant container (20); and counter-locking means (35) provided in an end region (39) of the propellant container receptacle (16) adjoining the opening (19) and cooperating with the locking member (25) of the propellant container (20).

8. A propellant container receptacle according to claim 7, wherein the counter-locking means (35) comprises a first counter-locking element (36) for releasably securing the propellant receptacle (20) in a first locking position.

9. A propellant container receptacle according to claim 8, wherein the counter-locking means (35) comprises a second counter-locking element (37) for releasably securing the propellant receptacle (20) in a second locking position.

10. A propellant container receptacle according to claim 7, further comprising at least one element for securing the propellant container (20) in the container receptacle (16) without the possibility of rotation relative thereto, and cooperating with a corresponding element of the propellant container.

11. A propellant container receptacle according to claim 10, wherein the at least one securing element is formed as a rib-shaped projection (44, 45) extending in a direction of a longitudinal axis (L2) and receivable in a groove-shaped recess (41, 42) provided on the terminal element (24) and extending in a direction of a longitudinal axis (L1) of the propellant container (20).
